(19) United States
(12) Patent Application Publication
(10) Pub. No.: US 2011/0101908 A1
(43) Pub. Date: May 5, 2011

(54) PORTABLE POWER SUPPLY DEVICE POWERED BY CELL PHONE BATTERY

(76) Inventor: Chung Te Liao, Taipei City (TW)

(21) Appl. No.: 12/610,357

(22) Filed: Nov. 2, 2009

(51) Int. Cl. H02J 7/00; H02J 1/10

(52) U.S. Cl. 320/103; 307/43

(57) ABSTRACT

A portable power supply device powered by a cell phone battery essentially includes a base, at least one receiving recess, a charging element, and at least one electrical connection element, wherein each of the at least one receiving recess is configured for receiving a cell phone battery. In addition to charging at least one cell phone battery via the charging element, the portable power supply device is also capable of supplying electric power from at least one cell phone battery to an external electronic device via the at least one electrical connection element coupled to the external electronic device.

### BACKGROUND OF THE INVENTION

1. Technical Field

The present invention relates to portable power supply devices and, more particularly, to a portable power supply device powered by a cell phone battery.

2. Description of Related Art

The means of telecommunication have advanced from the traditional landline telephones to wireless mobile phones, or cell phones, which, due to their portability, are increasingly popular nowadays, even to such extent that a lot of people find them indispensable. In fact, cell phones have gone way beyond the role of a tool with which two parties can talk to each other. Modern cell phones are equipped with constantly evolving and more and more user-friendly functions, not to mention such relatively common ones as making video calls, taking pictures, and sending and receiving e-mails. As cell phones vary by model, so do batteries and charging devices for use with the cell phones. These charging devices, however, are designed for specific cell phone models only. Cell phones manufactured under the same brand name but having different model numbers cannot share their charging devices with one another. Furthermore, as a cell phone battery charging device is intended only to charge cell phone batteries of a particular model number, if the cell phone it serves is to be discarded, the charging device and the batteries will have no other use than to be thrown away.

### BRIEF SUMMARY OF THE INVENTION

Therefore, it is a primary objective of the present invention to provide a power supply device essentially including a base, at least one receiving recess, a charging element, and at least one electrical connection element, wherein each of the at least one receiving recess is configured for receiving a cell phone battery. In addition to charging at least one cell phone battery via the charging element, the portable power supply device is also capable of supplying electric power from at least one cell phone battery to an external electronic device via the at least one electrical connection element coupled to the external electronic device.

It is a secondary objective of the present invention to provide the foregoing power supply device wherein each of the at least one receiving recess is provided with a plurality of resilient elements such that, after a cell phone battery is placed in one of the at least one receiving recess, the corresponding resilient elements press tightly and resiliently against the cell phone battery and thus prevent the cell phone battery from getting loose or falling off. In addition, the resilient elements also enable the at least one receiving recess to receive cell phone batteries of different specifications.

It is another objective of the present invention to provide the foregoing power supply device wherein the at least one electrical connection element is detachable from the base and is replaceable by electrical connection elements of different specifications so as to suit the external electronic device to be connected to.

It is yet another objective of the present invention to provide the foregoing power supply device wherein the charging element is detachable from the base such that it is possible to connect charging elements of different specifications or existing charging elements directly to the base.

### BRIEF DESCRIPTION OF THE SEVERAL VIEWS OF THE DRAWINGS

The technical means and structure adopted by the present invention to achieve the above and other objectives can be best understood by referring to the following detailed description of the preferred embodiment in conjunction with the accompanying drawings, in which:

FIG. 1 is a perspective view of a power supply device according to the present invention;

FIG. 2 is a perspective, partially see-through view of the power supply device shown in FIG. 1;

FIG. 3 is a perspective view showing operation of a power supply device according to a preferred embodiment of the present invention;

FIG. 4 is another perspective view showing operation of the power supply device according to the preferred embodiment of the present invention;

FIG. 5 is still another perspective view showing operation of the power supply device according to the preferred embodiment of the present invention;

FIG. 6 is a perspective view of a power supply device according to a further embodiment of the present invention;

FIG. 7 is a perspective view of a power supply device according to yet another embodiment of the present invention; and

FIG. 8 is a perspective view of a power supply device according to still another embodiment of the present invention.

### DETAILED DESCRIPTION OF THE INVENTION

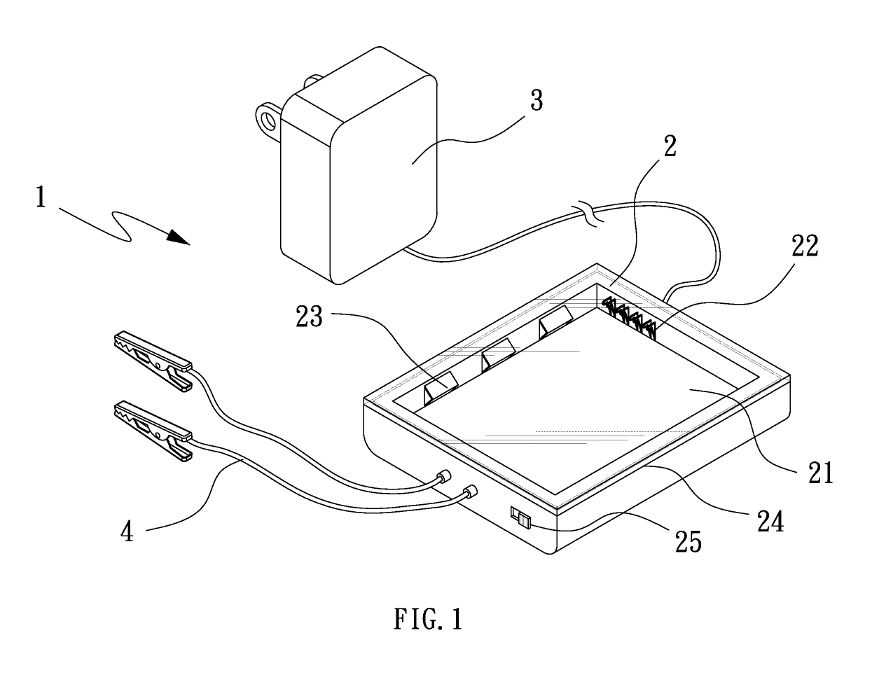

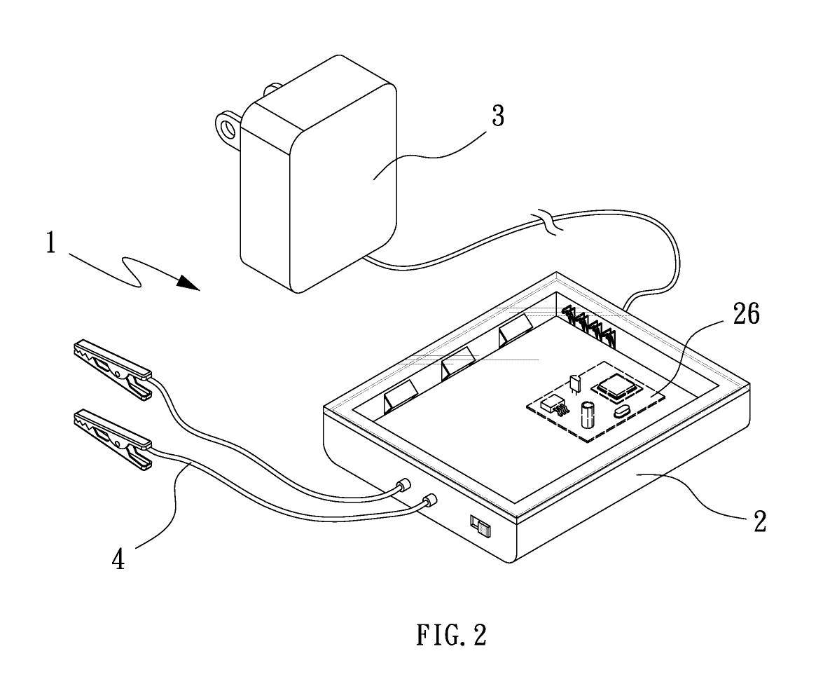

Refer to FIG. 1 and FIG. 2 for a perspective view and a perspective, partially see-through view of a power supply device 1 according to the present invention, respectively. The power supply device 1 primarily includes a base 2, at least one receiving recess 21, a charging element 3, and at least one electrical connection element 4.

As shown in FIG. 1 and FIG. 2, the base 2 is provided therein with a charging/discharging voltage stabilizing circuit board 26 and is configured for receiving related electronic components. A voltage adjusting knob 25 is provided at an external side of the base 2.

As shown in FIG. 1 and FIG. 2, the receiving recess 21 is formed as an open space in the base 2 and is configured for receiving a cell phone battery. The receiving recess 21 is provided therein with at least one set of electrical contacts 22 and a plurality of resilient elements 23. In addition, the receiving recess 21 is covered by a movable cover plate 24 pivotally coupled to a side of the base 2.

As shown in FIG. 1 and FIG. 2, the charging element 3 is coupled to a side of the base 2. The at least one electrical connection element 4 is coupled to a side of the base 2 and is configured for connecting with an external electronic device.

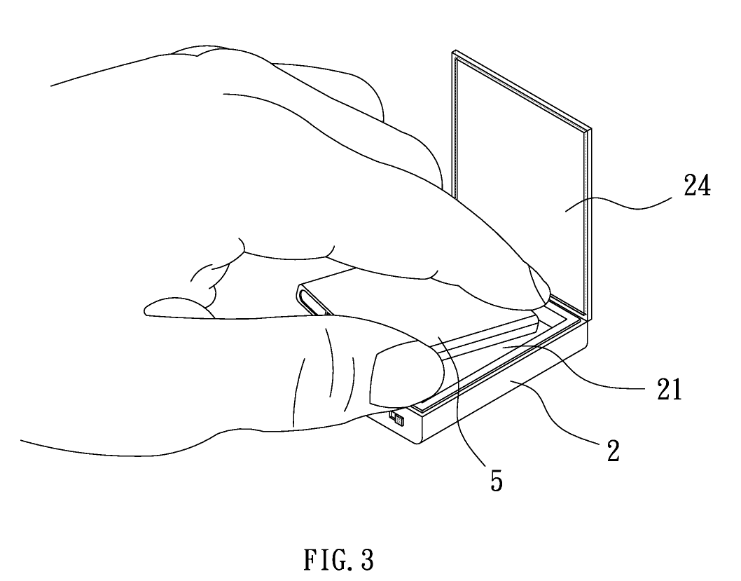

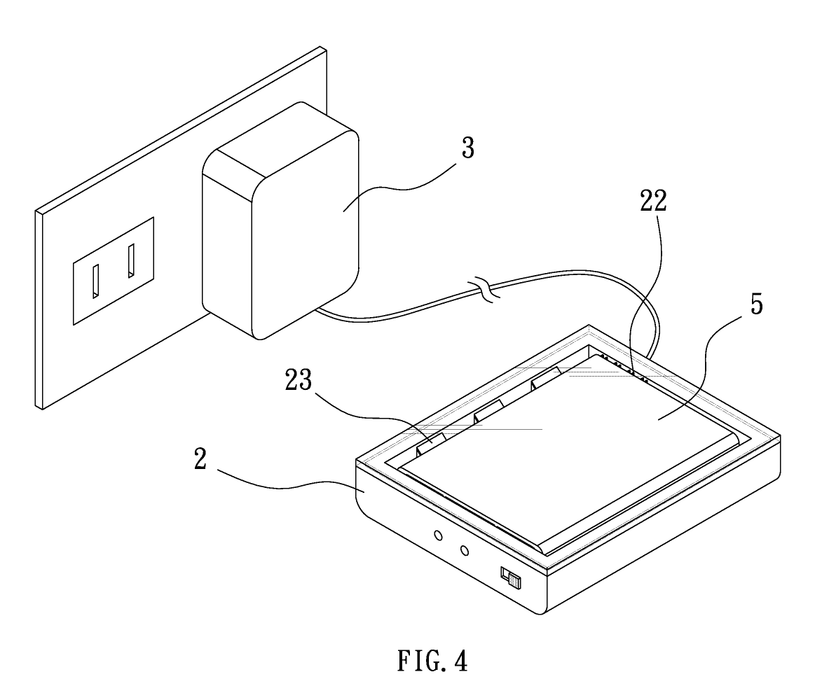

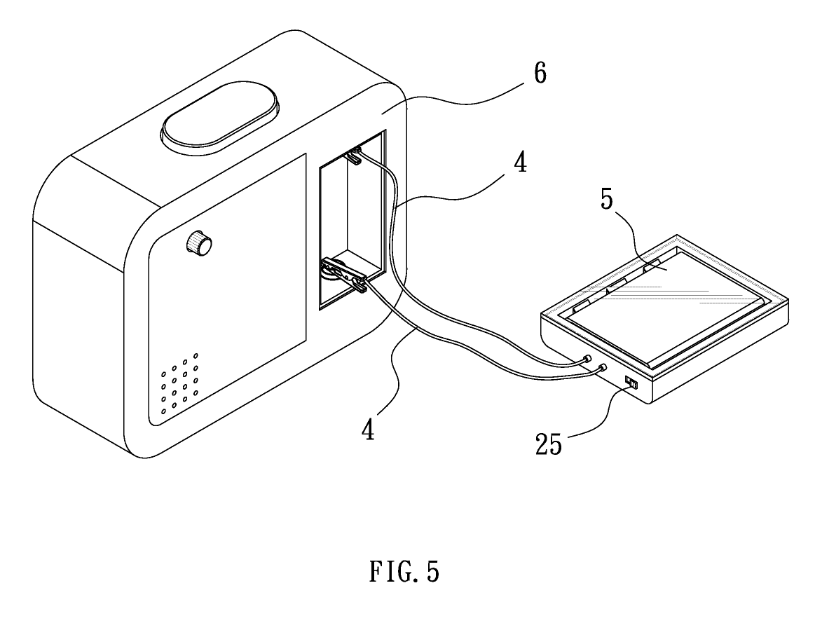

Refer to FIG. 3, FIG. 4, and FIG. 5 for operation of a preferred embodiment of the present invention. As shown in the drawings, a depleted cell phone battery 5 is put into the receiving recess 21 formed in the base 2 of the power supply device 1, and the cover plate 24 is subsequently lowered to cover the receiving recess 21. The charging element 3 is connected to mains electricity so as to charge the cell phone battery 5. When the cell phone battery 5 is fully charged, the at least one electrical connection element 4 coupled to a side of the base 2 is electrically connected to an external electronic device 6, and an appropriate output voltage is selected with the voltage adjusting knob 25, so as for the cell phone battery 5 to provide the electronic device 6 with the electric power needed.

In addition, when the cell phone battery 5 is placed in the receiving recess 21 and electrically connected with the electrical contacts 22, the plural resilient elements 23 in the receiving recess 21 press tightly and resiliently against the cell phone battery 5. Consequently, the cell phone battery 5 is positioned securely in the receiving recess 21 and is prevented from getting loose or falling off due to external factors, so as to ensure that the cell phone battery 5 is properly charged. Moreover, the plural resilient elements 23 in the receiving recess 21 also allow the receiving recess 21 the flexibility to receive cell phone batteries 5 of different specifications.

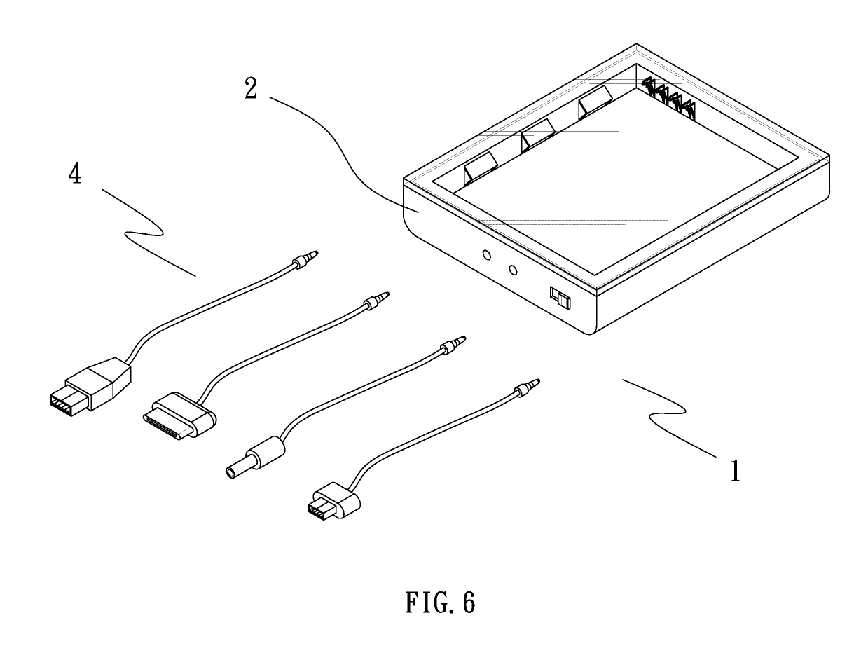

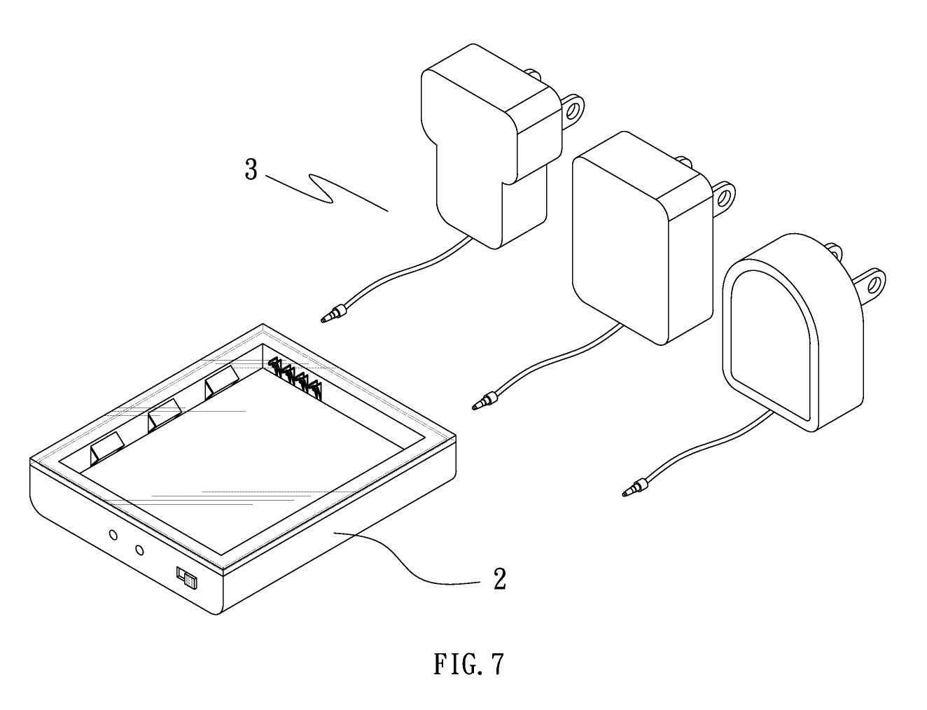

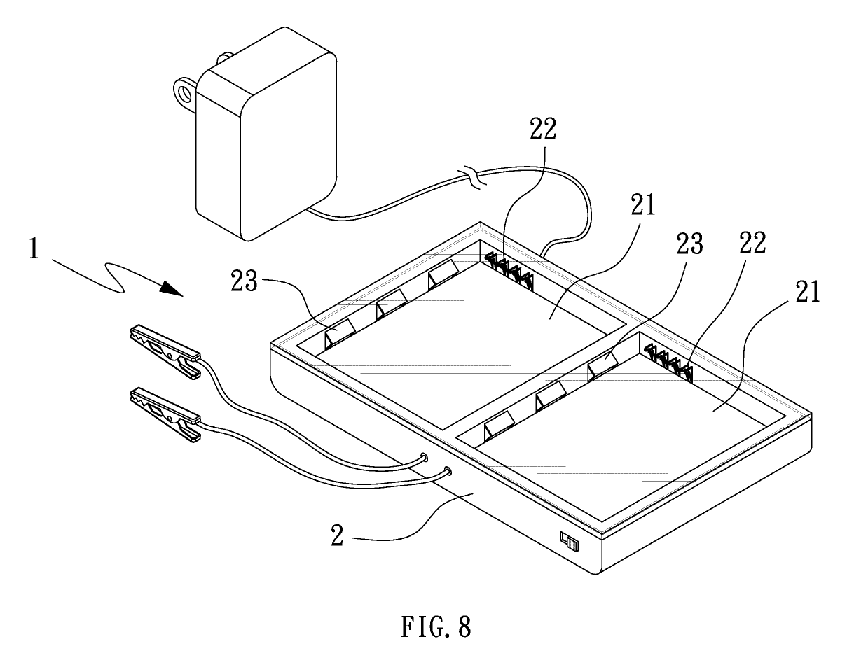

Refer to FIG. 6, FIG. 7, and FIG. 8 for further embodiments of the present invention. As the at least one electrical connection element 4 and the charging element 3 are both detachable from the base 2, it is possible to use electrical connection elements 4 of different specifications so as to supply electric power to different external electronic devices; it is also possible to use charging elements 3 of different specifications or use existing charging element 3 in conjunction with the power supply device 1. Besides, the base 2 may be formed with a plurality of receiving recesses 21, each provided therein with at least one set of electrical contacts 22 and a plurality of resilient elements 23. Thus, not only is the power supply device 1 enabled to charge several cell phone batteries at the same time, but also sustained power supply to an external electronic device is achievable by placing plural cell phone batteries in the plural receiving recesses 21.

In short, the power supply device 1 of the present invention is advantageous over the conventional charging devices in the following ways:

1. In addition to the charging function of the conventional charging devices, the power supply device 1 is also capable of supplying electric power to an external electronic device via the at least one electrical connection element 4 provided at a side of the base 2;

2. The at least one receiving recesses 21 is provided therein with the plural resilient elements 23 which not only press resiliently against and thereby securely position the cell phone battery or batteries 5 in the at least one receiving recess 21, but also allow the at least one receiving recess 21 to accommodate cell phone batteries 5 of different specifications, which is unattainable by the conventional charging devices designed for charging cell phone batteries only of a particular model number; and

3. The at least one electrical connection element 4 is detachable from the base 2 and replaceable by electrical connection elements 4 of different specifications so as to enable power supply to various external electronic devices.

What is claimed is:

1. A portable power supply device powered by a cell phone battery, the portable power supply device essentially comprising:
a base for receiving;
at least a receiving recess formed as an open space in the base and configured for receiving a said cell phone battery;
a charging element coupled to a side of the base; and
at least an electrical connection element coupled to a side of the base;
wherein at least a said cell phone battery is placed in the at least a receiving recess formed in the base so as for the at least a said cell phone battery to be charged, and wherein the at least an electrical connection element is coupled to an external electronic device so as for the at least a said cell phone battery to supply electric power to the external electronic device.

2. The portable power supply device of claim 1, wherein the base is provided therein with a charging/discharging voltage stabilizing circuit board.

3. The portable power supply device of claim 1, wherein each of the at least a receiving recess is provided with at least a set of electrical contacts and a plurality of resilient elements.

4. The portable power supply device of claim 1, wherein a movable cover plate is pivotally coupled to a side of the base so as to cover the at least a receiving recess.

5. The portable power supply device of claim 1, wherein a voltage adjusting knob is provided at a side of the base for controlling an output voltage.

6. The portable power supply device of claim 1, wherein the at least an electrical connection element is detachable from the base.

7. The portable power supply device of claim 1, wherein the charging element is detachable from the base.
